(19) United States
(12) Patent Application Publication
(10) Pub. No.: US 2023/0334415 A1
(43) Pub. Date: Oct. 19, 2023

(54) METHOD AND SYSTEM FOR DETERMINING CUSTOMER-FACING INVENTORY FOR ONLINE AND OFFLINE ENVIRONMENTS

(71) Applicant: Flipkart Internet Private Limited, Bengalore (IN)

(72) Inventors: Akanksha Garg, Bathinda (IN); Balaji SRIHARI, Bangalore (IN); Gautam Kumar P, Bangalore (IN); K. Chandrasekhar, Bangalore (IN); S Asan Kumar, Bangalore (IN); Chandan Kumar, Bangalore (IN); Atul Anand, Thane (West) (IN)

(21) Appl. No.: 18/047,298

(22) Filed: Oct. 18, 2022

(30) Foreign Application Priority Data
Apr. 19, 2022 (IN) 202241021884

(51) Int. Cl. G06Q 10/087; G06Q 30/0601

(52) U.S. Cl. CPC G06Q 10/087; G06Q 30/0641

(57) ABSTRACT

A method and system for determining customer-facing inventory for online and offline environments are disclosed. Method includes receiving promise engine data and calculating duration of OOS for each hour of day for each product listing ID of product listing identities (IDs), using timestamps received via promise engine data. Method includes analyzing in-stock of products and appending listings to create single in-stock number at product level and dark store level for day. Method includes determining in-stock waterfall at product level and dark store level for day and each hour, and comparing determined in-stock waterfall with inventory data at product level and dark store level for day and each hour/timestamps in day, to isolate symmetrical issues related to visibility of accurate inventory. The method includes outputting decrease in-sale conversion rate and impact of OOS on order loss for products as customer-facing inventory for online/offline environments when the product is in-stock or OOS.

### CROSS-REFERENCE TO RELATED APPLICATIONS

This application claims the benefit under 35 U.S.C. § 119(b) of Indian Patent Application No. 202241021884, filed on Apr. 19, 2022, which application is incorporated herein by reference in its entirety.

### FIELD OF INVENTION

The embodiments of the present disclosure generally relate to inventory handling systems. More particularly, the present disclosure relates to a method and a system for determining customer-facing inventory for online and offline environments.

### BACKGROUND

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of the prior art.

Generally, inventory availability may be a key to generating enough customer engagement through add-to-cart and checkout events in an e-commerce platform. The add-to-cart and checkout events may directly impact the conversion of the e-commerce business. With increasing competition in the market, every retail business should track in-stock as a metric and keep the in-stock metric healthy, as the in-stock metric can decide which e-commerce platform a consumer may retain.

Conventionally, when a product is out of stock and/or shown as “currently unavailable” in the e-commerce platform, then the in-stock metric may be driven by using a number of product page views. This conventional method may not be pertinent for hyperlocal businesses, since the order flow may not need the customers to go to the product page view. Instead, the hyperlocal businesses may allow interaction and add-to-cart of products from the home page. Another conventional method may include measuring in-stock using inventory availability in a dark store. The dark store may generally be a large warehouse that can either be used to facilitate a “click-and-collect” service, where a customer collects an item, they have ordered online, or as an order fulfillment platform for online sales. Measuring the in-stock using inventory availability in the dark store may not be enough, since the view of inventory availability that the customer is able to view on the e-commerce platform could be significantly different from a physical inventory availability in the dark store. Further, the aforementioned conventional methods may not provide a drop-in conversion and may not be able to isolate systemic issues related to the visibility of accurate inventory on the e-commerce platform. For instance, consider the e-commerce platform where a conversion can occur only from a Product Page View (PPV) as shown in FIGS. 1A, 1B, and 1C. The PPVs may be tracked with Out of Stock (OOS) information, hence in-stock may be defined at a product listing Identity (ID) level as shown in equation 1 below:

In-stock=Σ(In Stock PPVs)/Σ(Total PPVs) Equation 1

In another instance, consider a hyperlocal market and Super Mart market, in which add-to-cart may occur from a product listing page itself as shown in FIGS. 1D and 1E lead to no PPV data available for in-stock computation. Consider, there may be, for example, two approaches which are usually taken to define the in-stock in above case. One approach would be to track Out of stock (OOS) information at impression/view level, hence in-stock may be defined at product listing ID level as shown in equation 2 below:

In-stock=Σ(In Stock Impressions)/Σ(Total Impressions) Equation 2

In the above equation 2, impressions may be defined as the number of customers who saw this section of the page for ‘x’ seconds. Another approach may include inventory-based in-stock determination. This includes: a) Granularity: Product*Dark store*Day*hour (6 AM, 10 AM, 4 PM, 8 PM) inventory data. b) Flag at Product*Dark store*Day*hour, if Inventory>0 then 1 else 0. c) In-stock at Product*Dark store*Day=(#instances with flag=1)/(Total instances). d) Product*Dark store*day data can be aggregated to any level required with a simple averaging method.

However, the aforementioned approaches may have disadvantages as the PPV approach may not be viable as the number of PPVs in hyperlocal and Super Mart platform may be very sparse. Further, tracking OOS information at the impression level may not be economic, as tracking OOS information may be third party dependent (Omniture). Further, in inventory-based approach, given that it is based on inventory data, it might not be what the customer sees because of various technical issues. The inventory-based approach may not take into account the OOS occurring because of low inventory at the start of the hour. Further, only e.g., four time stamps a day does not ensure that in-stock is computed accurately and leaves huge gaps between the hours when inventory snapshot is available.

Therefore, there is a need for a method and a system for solving the shortcomings of the current technologies, by providing a method and a system for determining customer-facing inventory for online and offline environments.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may be for determining customer-facing inventory for online and offline environments.

It is an object of the present disclosure to provide a method and a system for determining customer-facing inventory for online and offline environments.

It is another object of the present disclosure to help leveraging promise engine data to provide a view of customer facing product availability at a granularity of every minute in every dark store.

It is an object of the present disclosure to provide an in-stock metric to help determine drop in conversion of product purchase.

It is another object of the present disclosure to help isolating systemic/technical issues related to the visibility of accurate inventory on a platform.

It is another object of the present disclosure to provide a weighted average of the product availability with traffic to the platform during that particular hour of the day, that enables in-stock metric more useful and helps with insights to ensure increased product availability during certain time of the day.

It is yet another object of the present disclosure to help comparing actual inventory snapshots with what is shown to the customer, which in turn helps with accurately identifying instances of product-dark store-hour combination, when technical related challenges led to drop in product availability. This information enables the teams to resolve technical related issues and ensure that all available inventory is visible in the platform.

It is another object of the present disclosure to compare existing approach of physically available inventory at the dark store with the product listing availability on the platform to attribute exact quantum of systemic/technical related issues to loss of sales.

In an aspect, the present disclosure provides a method for determining customer-facing inventory for online and offline environments. The method includes receiving promise engine data comprising one or more timestamps associated with one or more product listing identity (ID) being at least one of an Out of Stock (OOS) of one or more products and an in-stock of one or more products. Further, the method includes calculating a duration of OOS for each hour of a day for each product listing ID of one or more product listing identities (IDs), using the one or more timestamps received via the promise engine data. Furthermore, the method includes analyzing the in-stock of the one or more products associated with the one or more product listing ID for the day, based on a total number of one or more OOS visits and one or more total visits associated with the one or more product listing IDs, upon calculating the duration of OOS for each hour of the day. The OOS visits and the one or more total visits is received via the promise engine data. Thereafter, the method includes appending one or more listings of each product listing ID from the one or more product listing IDs, to create a single in-stock number at a product level and a dark store level for the day, upon analyzing the in-stock of the one or more products associated with the one or more product listing ID for the day. Further, the method includes determining in-stock waterfall at a product level and a dark store level for the day and each hour, based on the appended one or more listings of each product listing ID. Thereafter, the method includes comparing the determined in-stock waterfall with inventory data at a product level and a dark store level for the day and each hour, for two or more timestamps in the day, to isolate one or more symmetrical issues related to the visibility of accurate inventory. Furthermore, the method includes, outputting a decrease in sale conversion rate and the impact of OOS on order loss for one or more products as a customer-facing inventory for online and offline environments, when one or more product is at least one of the in-stock and the OOS, upon comparing in-stock waterfall with inventory data at a product level and a dark store level for the day and each hour.

In an embodiment, creating the single in-stock number at the product level and the dark store level for the day further includes sorting with respect to time, the appended one or more listings of each product listing ID in ascending order of the time. Further, the method includes incrementing a flag value, if the one or more products are OOS and decrementing the flag value, if the one or more products is in-stock. Furthermore, the method includes determining if the flag value is equal to a number of appended one or more listings of each product listing ID. Thereafter, the method includes displaying all the appended listings as OOS, when the flag value is equal to the number of appended one or more listings of each product listing ID.

In an embodiment, all the appended listings is displayed based on determining number of instances with inventory of one or more products equal to zero and in-stock of one or more products is equal to zero for a total number of instances. In an embodiment, the promise engine data includes a view of customer facing product availability at a granularity of every minute in each dark store.

In an embodiment, the in-stock comprises a partial in-stock, which is determined based on in-stock, symmetrical issue and OOS of all the appended listings. The in-stock comprises a product listing availability which is determined based on chronological data for each product listing ID to provide a flag value for the in-stock and the OOS. The product listing availability includes the one or more product listing IDs, availability flag, one or more timestamps.

In an embodiment, the one or more listings includes at least one of listing IDs, product IDs, dark-store IDs, listing status, and listing creation information.

In an embodiment, the symmetrical issues include one or more technical issues, which is determined based on number of instances with inventory of one or more products greater than zero and in-stock of one or more products is equal to zero for a total number of instances.

In another embodiment, the one or more total visits includes day level visits and hour level visits for every city.

In another aspect, the present disclosure provides a system for determining customer-facing inventory for online and offline environments. The system receives promise engine data comprising one or more timestamps associated with one or more product listing identity (ID) being at least one of an Out of Stock (OOS) of one or more products and an in-stock of one or more products. Further, the system calculates a duration of OOS for each hour of a day for each product listing ID of one or more product listing identities (IDs), using the one or more timestamps received via the promise engine data. Furthermore, the system analyzes the in-stock of the one or more products associated with the one or more product listing ID for the day, based on a total number of one or more OOS visits and one or more total visits associated with the one or more product listing IDs, upon calculating the duration of OOS for each hour of the day. The OOS visits and the one or more total visits is received via the promise engine data. Thereafter, the system appends one or more listings of each product listing ID from the one or more product listing IDs, to create a single in-stock number at a product level and a dark store level for the day, upon analyzing the in-stock of the one or more products associated with the one or more product listing ID for the day. Further, the system determines in-stock waterfall at a product level and a dark store level for the day and each hour, based on the appended one or more listings of each product listing ID. Thereafter, the system compares the determined in-stock waterfall with inventory data at a product level and a dark store level for the day and each hour, for two or more timestamps in the day, to isolate one or more symmetrical issues related to the visibility of accurate inventory. Further, the system outputs a decrease in sale conversion rate and impact of OOS on order loss for the one or more products as a customer-facing inventory for online and offline environments, when the one or more product is at least one of the in-stock and the OOS, upon comparing in-stock waterfall with inventory data at a product level and a dark store level for the day and each hour.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that the invention of such drawings includes the invention of electrical components, electronic components, or circuitry commonly used to implement such components.

FIGS. 1A, 1B and 1C illustrate exemplary schematic diagram representations of a Product Page View (PPV) in an e-commerce platform.

FIGS. 1D and 1E illustrate exemplary schematic diagram representations of a product listing page in a hyperlocal market and Super Mart platform.

FIG. 2 illustrates an exemplary block diagram representation of a network architecture implementing a proposed system for determining customer-facing inventory for online and offline environments, according to embodiments of the present disclosure.

FIG. 3A illustrates an exemplary detailed block diagram representation of the proposed system, according to embodiments of the present disclosure.

FIG. 3B illustrates an exemplary graph diagram representation of time stamps of a product listing ID being Out of Stock (OOS) and in stock, according to embodiments of the present disclosure.

FIG. 3C illustrates an exemplary graph diagram representation of Out of Stock (OOS) determination for multiple product listings on a platform for the same product and dark store combination, according to embodiments of the present disclosure.

FIG. 3D illustrates exemplary tables of timestamps for combining multiple product listings to determine product listing ID being Out of Stock (OOS) and in stock, according to embodiments of the present disclosure.

FIG. 4 illustrates a flow chart depicting a method of determining customer-facing inventory for online and offline environments, according to embodiments of the present disclosure.

FIG. 5 illustrates a hardware platform for the implementation of the disclosed system according to embodiments of the present disclosure.

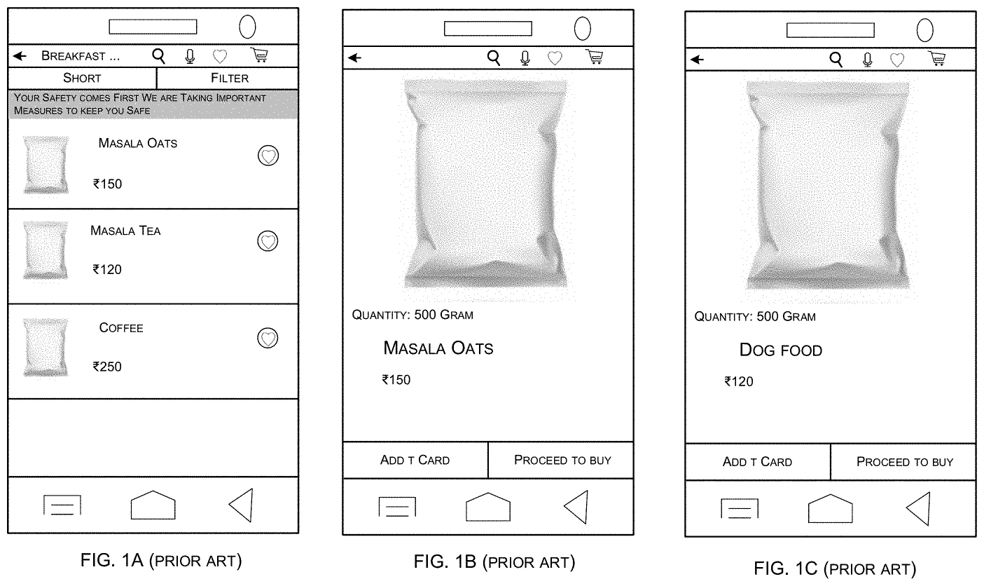

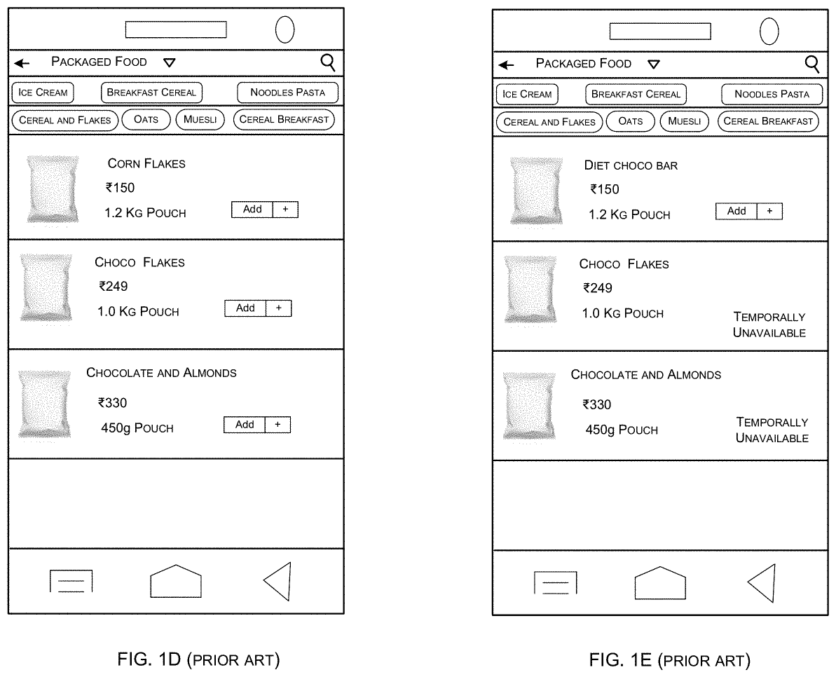

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provide a method and a system for determining customer-facing inventory for online and offline environments. The present disclosure helps in leveraging promise engine data to provide a view of customer-facing product availability at a granularity of every minute in every dark store. The present disclosure provides an in-stock metric to help determine drop in conversion of product purchase. The present disclosure helps in isolating systemic/technical issues related to the visibility of accurate inventory on a platform. The platform may include, but are not limited to, electronic commerce (e-commerce), a hyperlocal platform, a super mart platform, and the like. The present disclosure provides a weighted average of the product availability with traffic to the platform during that particular hour of the day, which enables in-stock metric more useful and helps with insights to ensure increased product availability during certain time of the day. The present disclosure helps in comparing actual inventory snapshots with what is shown to the customer, which in turn helps with accurately identifying instances of product-dark store-hour combination, when technical related challenges led to drop in product availability. This information enables the teams to resolve technical related issues and ensure that all available inventory is visible in the platform. The present disclosure compares existing approach of physically available inventory at the dark store with the product listing availability on the platform to attribute exact quantum of systemic/technical related issues to loss of sales.

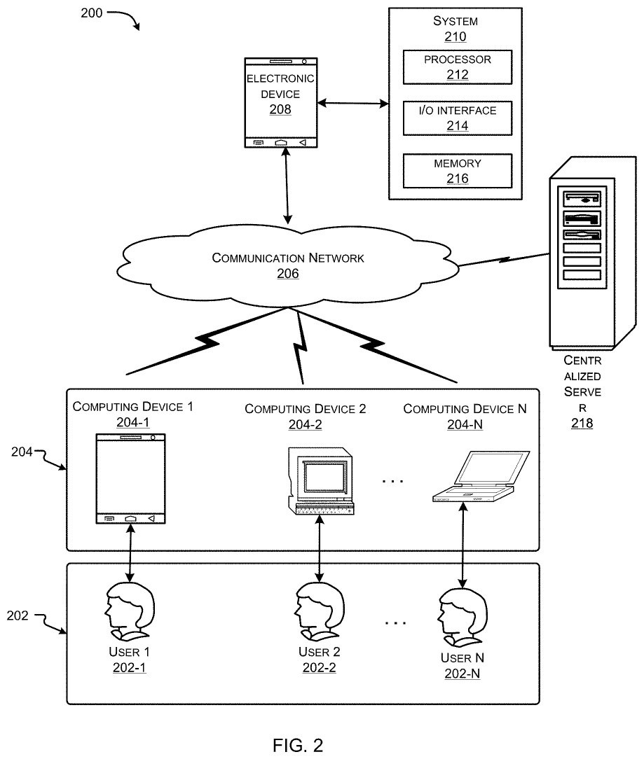

FIG. 2 illustrates an exemplary block diagram representation of a network architecture 200 implementing a proposed system 210 for determining customer-facing inventory for online and offline environments, according to embodiments of the present disclosure. The network architecture 200 may include the system 210, an electronic device 208, and a centralized server 218. The system 210 may be connected to the centralized server 218 via a communication network 206. The centralized server 218 may include, but are not limited to, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 206 may be a wired communication network or a wireless communication network. The wireless communication network may be any wireless communication network capable to transfer data between entities of that network such as, but are not limited to, a carrier network including circuit-switched network, a public switched network, a Content Delivery Network (CDN) network, a Long-Term Evolution (LTE) network, a New Radio (NR), a Global System for Mobile Communications (GSM) network and a Universal Mobile Telecommunications System (UMTS) network, an Internet, intranets, Local Area Networks (LANs), Wide Area Networks (WANs), mobile communication networks, combinations thereof, and the like.

The system 210 may be implemented by way of a single device or a combination of multiple devices that may be operatively connected or networked together. For instance, the system 210 may be implemented by way of a standalone device such as the centralized server 218, and the like, and may be communicatively coupled to the electronic device 208. In another instance, the system 210 may be implemented in/associated with the electronic device 208. In yet another instance, the system 210 may be implemented in/associated with respective computing device 204-1, 204-2, . . . , 204-N (individually referred to as computing device 204, and collectively referred to as computing devices 204), associated with one or more user 202-1, 202-2, . . . , 202-N (individually referred to as user 202, and collectively referred to as users 202). In such a scenario, the system 210 may be replicated in each of the computing devices 204. The users 202 may be a user of an e-commerce platform, a hyperlocal platform, a super mart platform, and the like. In some instances, the user 202 may include an entity/administrator. The electronic device 208 may be any electrical, electronic, electromechanical, and computing device. The electronic device 208 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, server, and the like. The system 210 may be implemented in hardware or a suitable combination of hardware and software. The system 210 or the centralized server may be associated with entities (not shown). The entities may include, but are not limited to, an e-commerce company, a company, an outlet, a manufacturing unit, an enterprise, a facility, an organization, an educational institution, a secured facility, and the like.

Further, the system 210 may include a processor 212, an Input/Output (I/O) interface 214, and a memory 216. The Input/Output (I/O) interface 214 on the system 210 may be used to receive user inputs, from one or more computing devices 204-1, 204-2, . . . 204-N (collectively referred to as computing devices 204 and individually referred to as computing device 204) associated with one or more users 202 (collectively referred as users 202 and individually referred as user 202).

Further, system 210 may also include other units such as a display unit, an input unit, an output unit, and the like, however the same are not shown in the FIG. 2, for the purpose of clarity. Also, in FIG. 2 only few units are shown, however, the system 210 or the network architecture 200 may include multiple such units or the system 210/network architecture 200 may include any such numbers of the units, obvious to a person skilled in the art or as required to implement the features of the present disclosure. The system 210 may be a hardware device including the processor 212 executing machine-readable program instructions to determine customer-facing inventory for online and offline environments. Execution of the machine-readable program instructions by the processor 212 may enable the proposed system 210 to determining customer-facing inventory for online and offline environments. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 212 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor 212 may fetch and execute computer-readable instructions in the memory 216 operationally coupled with the system 210 for performing tasks such as data processing, input/output processing, and/or any other functions. Any reference to a task in the present disclosure may refer to an operation being or that may be performed on data.

In the example that follows, assume that a user 202 of the system 210 desires to improve/add additional features for determining customer-facing inventory for online and offline environments. In this instance, the user 202 may include an administrator of a web site, an administrator of an e-commerce site, an administrator of a social media site, an administrator of an e-commerce application/social media application/other applications, an administrator of media content (e.g., television content, video-on-demand content, online video content, graphical content, image content, augmented/virtual reality content, metaverse content), among other examples, and the like. The system 210 when associated with the electronic device 208 or the centralized server 218 may include, but are not limited to, a touch panel, a soft keypad, a hard keypad (including buttons), and the like. For example, the user 202 may click a soft button on a touch panel of the electronic device 208 or the centralized server 218 to browse/shop/add-to-cart/perform other activities, but not limited to the like. In a preferred embodiment, the system 210 via the electronic device 208 or the centralized server 218 may be configured to add-to-cart/view product from the user 202 via a graphical user interface on the touch panel. As used herein, the graphical user interface may be a user interface that allows a user of the system 210 to interact with the system 210 through graphical icons and visual indicators, such as secondary notation, and any combination thereof, and may comprise of a touch panel configured to receive an input using a touch screen interface.

In an embodiment, the system 210 may receive promise engine data comprising one or more timestamps associated with one or more product listing identity (ID) being at least one of an Out of Stock (OOS) of one or more products and an in-stock of one or more products. In an embodiment, the promise engine data includes a view of customer facing product availability at a granularity of every minute in each dark store. In an embodiment, the in-stock includes a partial in-stock, which is determined based on in-stock, symmetrical issue and OOS of all the appended listings. The in-stock comprises a product listing availability which is determined based on chronological data for each product listing ID to provide a flag value for the in-stock and the OOS. The product listing availability includes, but are not limited to, the one or more product listing IDs, availability flag, one or more timestamps, and the like.

In an embodiment, the system 210 may calculate a duration of OOS for each hour of a day for each product listing ID of one or more product listing identities (IDs), using the one or more timestamps received via the promise engine data.

In an embodiment, the system 210 may analyze the in-stock of the one or more products associated with the one or more product listing ID for the day, based on a total number of one or more OOS visits and one or more total visits associated with the one or more product listing IDs, upon calculating the duration of OOS for each hour of the day. The OOS visits and the one or more total visits may be received via the promise engine data. In an embodiment, the one or more total visits includes day level visits and hour level visits for every city.

In an embodiment, the system 210 may append one or more listings of each product listing ID from the one or more product listing IDs, to create a single in-stock number at a product level and a dark store level for the day, upon analyzing the in-stock of the one or more products associated with the one or more product listing ID for the day. In an embodiment, the all the appended listings may be displayed based on determining number of instances with inventory of one or more products equal to zero and in-stock of one or more products is equal to zero for a total number of instances. In an embodiment, the one or more listings include at least one of listing IDs, product IDs, dark-store IDs, listing status, and listing creation information.

For creating the single in-stock number at the product level and the dark store level for the day, the system 210 may initially sort with respect to time, the appended one or more listings of each product listing ID in ascending order of the time. Further, the system 210 may increment a flag value, if the one or more products is OOS and decrementing the flag value, if the one or more products is in-stock. Furthermore, the system 210 may determine, if the flag value is equal to a number of appended one or more listings of each product listing ID. Thereafter, the system 210 may display all the appended listings as OOS, when the flag value is equal to the number of appended one or more listings of each product listing ID.

In an embodiment, the system 210 may determine in-stock waterfall at a product level and a dark store level for the day and each hour, based on the appended one or more listings of each product listing ID.

In an embodiment, the system 210 may compare the determined in-stock waterfall with inventory data at a product level and a dark store level for the day and each hour, for two or more timestamps in the day, to isolate one or more symmetrical issues related to visibility of accurate inventory. The symmetrical issues include one or more technical issues, which are determined based on number of instances with inventory of one or more products greater than zero and in-stock of one or more products is equal to zero for a total number of instances.

In an embodiment, the system 210 may output a decrease in sale conversion rate and impact of OOS on order loss for the one or more products as a customer-facing inventory for online and offline environments, when the one or more product is at least one of the in-stock and the OOS, upon comparing in-stock waterfall with inventory data at a product level and a dark store level for the day and each hour.

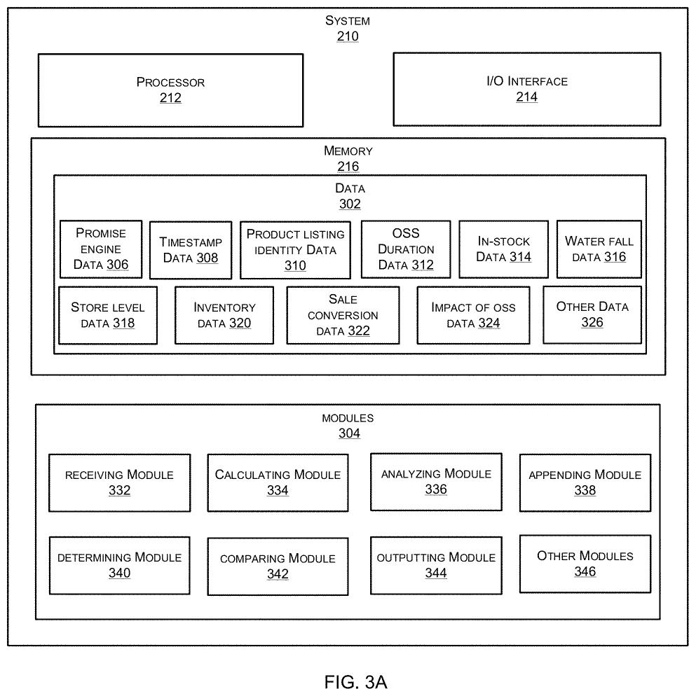

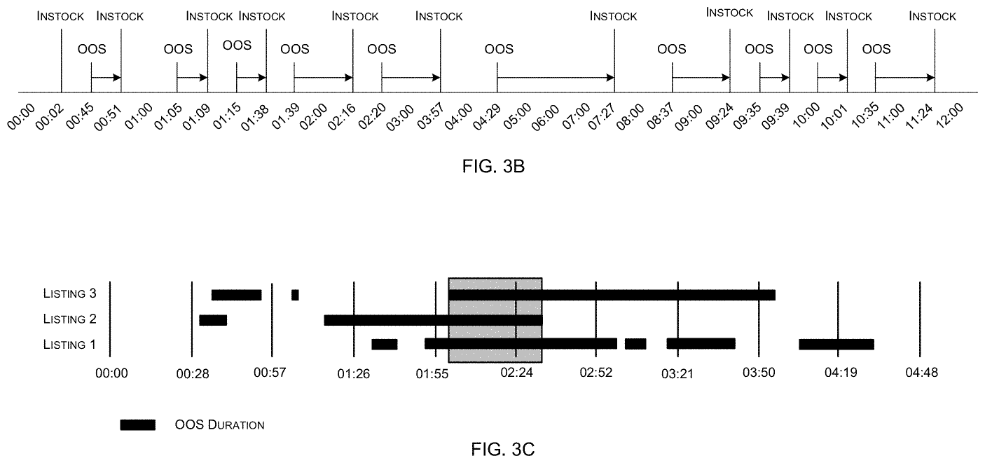

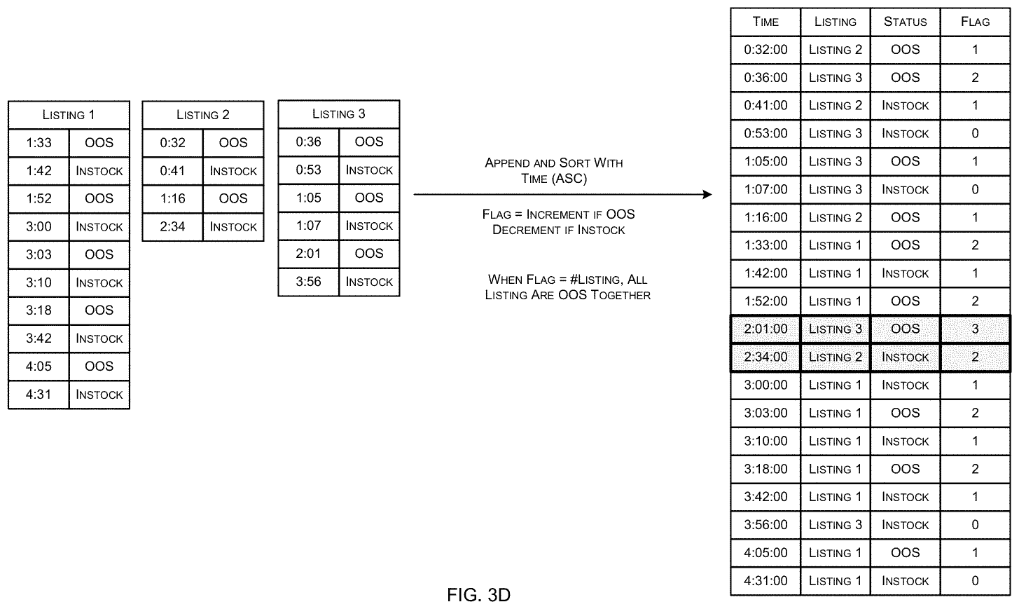

FIG. 3A illustrates a detailed block diagram representation of the proposed system 210, according to embodiments of the present disclosure. The system 210 may include the processor 212, the Input/Output (I/O) interface 214, and the memory 216. In some implementations, the system 210 may include data 302, and modules 304. As an example, the data 302 is stored in the memory 216 configured in the system 210 as shown in the FIG. 3A. In an embodiment, the data 302 may include promise engine data 306, time stamp data 308, product listing identity data 310, OSS duration data 312, in-stock data 314, water fall data 316, store level data 318, inventory data 320, sale conversion data 322, impact of OSS data 324, and other data 326. In an embodiment, the data 302 may be stored in the memory 216 in the form of various data structures. Additionally, the data 302 can be organized using data models, such as relational or hierarchical data models. The other data 318 may store data, including temporary data and temporary files, generated by the modules 304 for performing the various functions of the system 210.

In an embodiment, the modules 304, may include a receiving module 332, a calculating module 334, an analyzing module 336, an appending module 338, a determining module 340, a comparing module 342, an outputting module 344, and other modules 346.

In an embodiment, the data 302 stored in the memory 316 may be processed by the modules 304 of the system 210. The modules 304 may be stored within the memory 216. In an example, the modules 304 communicatively coupled to the processor 212 configured in the system 210, may also be present outside the memory 216, as shown in FIG. 3A, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 332 may receive promise engine data 306 comprising one or more timestamps associated with one or more product listing identity (ID) being at least one of an Out of Stock (OOS) of one or more products and an in-stock of one or more products. The one or more timestamps may be stored as the time stamp data 308, and the one or more product listing identity (ID) may be stored as the product listing identity data 310. In an embodiment, the promise engine data 306 includes a view of customer-facing product availability at a granularity of every minute in each dark store. In an embodiment, the in-stock includes a partial in-stock, which is determined based on in-stock, symmetrical issue and OOS of all the appended listings. The in-stock comprises a product listing availability which is determined based on chronological data for each product listing ID to provide a flag value for the in-stock and the OOS. The product listing availability includes, but are not limited to, the one or more product listing IDs, availability flag, one or more timestamps, and the like.

In an embodiment, the calculating module 334 may calculate a duration of OOS for each hour of a day for each product listing ID of one or more product listing identities (IDs), using the one or more timestamps received via the promise engine data. The calculated duration of OOS for each hour of a day for each product listing ID of one or more product listing identities (IDs) may be stored as the OSS duration data 312.

In an embodiment, the analyzing module 336 may analyze the in-stock of the one or more products associated with the one or more product listing ID for the day, based on a total number of one or more OOS visits and one or more total visits associated with the one or more product listing IDs, upon calculating the duration of OOS for each hour of the day. The analyzed in-stock of the one or more products may be stored as the in-stock data 314. The OOS visits and the one or more total visits may be received via the promise engine data 306. In an embodiment, the one or more total visits includes day level visits and hour level visits for every city.

In an embodiment, the appending module 338 may append one or more listings of each product listing ID from the one or more product listing IDs, to create a single in-stock number at a product level and a dark store level for the day, upon analyzing the in-stock of the one or more products associated with the one or more product listing ID for the day. In an embodiment, the all the appended listings may be displayed based on determining number of instances with inventory of one or more products equal to zero and in-stock of one or more products is equal to zero for a total number of instances. In an embodiment, the one or more listings include at least one of listing IDs, product IDs, dark-store IDs, listing status, and listing creation information.

For creating the single in-stock number at the product level and the dark store level for the day, the system 210 may initially sort with respect to time, the appended one or more listings of each product listing ID in ascending order of the time. Further, the system 210 may increment a flag value, if the one or more products is OOS and decrementing the flag value, if the one or more products is in-stock. Furthermore, the system 210 may determine, if the flag value is equal to a number of appended one or more listings of each product listing ID. Thereafter, the system 210 may display all the appended listings as OOS, when the flag value is equal to the number of appended one or more listings of each product listing ID.

In an embodiment, the determining module 340 may determine in-stock waterfall at a product level and a dark store level for the day and each hour, based on the appended one or more listings of each product listing ID. The determined in-stock waterfall at a product level and a dark store level for the day and each hour may be stored as the water fall data 316. Further, the product level and the dark store level may be stored as the store level data 318.

In an embodiment, the comparing module 342 may compare the determined in-stock waterfall with the inventory data 320 at a product level and a dark store level for the day and each hour, for two or more timestamps in the day, to isolate one or more symmetrical issues related to visibility of accurate inventory. The symmetrical issues include one or more technical issues, which are determined based on number of instances with inventory of one or more products greater than zero and in-stock of one or more products is equal to zero for a total number of instances.

In an embodiment, the outputting module 344 may output a decrease in sale conversion rate and impact of OOS on order loss for the one or more products as a customer-facing inventory for online and offline environments, when the one or more product is at least one of the in-stock and the OOS, upon comparing in-stock waterfall with inventory data at a product level and a dark store level for the day and each hour. The decrease in sale conversion rate may be stored as the sale conversion data 322, and the impact of OOS on order loss may be stored as the impact of OSS data 324.

### Exemplary Scenario

Consider, a scenario of calculating in-stock metric for a product listing ID. The promise engine data 306 may provide an exact timestamp of a product listing ID being Out of Stock (OOS) and in-stock as shown in FIG. 3B. Using this exact time stamps the system 210 may calculate the number of minutes (#minutes) OOS for each hour of the day for every product listing ID using Table 1 below:

TABLE 1

| Hour | 0 | 1 | 2 | 3 | 4 | 5 | 6 | 7 | 8 | 9 | 10 | 11 |
|---|---|---|---|---|---|---|---|---|---|---|---|---|
| #Minute | 6 | 48 | 56 | 57 | 31 | 60 | 60 | 27 | 23 | 28 | 26 | 24 |
| OSS | | | | | | | | | | | | |
| Visits | 2694 | 1486 | 696 | 410 | 426 | 474 | 1776 | 3330 | 4502 | 4210 | 8028 | 7060 |
| OSS | 269 | 1189 | 650 | 390 | 220 | 674 | 1776 | 1499 | 1726 | 2898 | 3479 | 2824 |
| Visits | | | | | | | | | | | | |

Consider, for example, from the Table 1, there were 2694 user visits to product listing, for the day and hour in question and the product listing was OOS for 6 minutes, which is 10% of the time. Accordingly, it may be safe to assume that 269 (i.e., 10% of 2694) visits of users 202 would have seen the product to be OOS. Based on the above exemplary data, in-stock for any product listing ID for the day can be defined as shown in equation 3 below:

In-stock=1−(Σ(OOS Visits)/Σ(Total Visits)) Equation 3

Consider, there could be multiple product listings on the e-commerce/hyperlocal/super mart platform for the same product and dark store combination. For the user 202 only the product matters, a product may be considered to be OOS only if all the listings are OOS at the same time as shown in FIG. 3C. All the listings are combined to create single in-stock number at product, dark store and day level (Product*Dark store*Day level).

In an instance, an exemplary implementation of combining the multiple product listings may be as shown in FIG. 3D. The system 210 may append one or more listings of each product listing ID from the one or more product listing IDs, to create a single in-stock number at a product level and a dark store level for the day. The system 210 may sort with respect to time, the appended one or more listings of each product listing ID in ascending order of the time. Further, the system 210 may increment a flag value, if the one or more products is OOS and decrementing the flag value, if the one or more products is in-stock. Further, the system 210 may determine, if the flag value is equal to a number of appended one or more listings of each product listing ID. Furthermore, the system 210 may display all the appended listings as OOS, when the flag value is equal to the number of appended one or more listings of each product listing ID.

Based on the aforementioned appending, sorting and incrementing approaches, the in-stock may be calculated at product, dark store, and day level (i.e., Product*Dark store*Day level). After that, the in-stock can be aggregated to any level required with a simple averaging method.

In another instance, consider a scenario for determining a product in-stock waterfall. The product in-stock waterfall may be calculated based on product, dark store, day, and hour level (i.e., Product*Dark store*Day*Hour level). The in-stock is then compared with the inventory data 320 at the same level for 4 timestamps (e.g., 6 AM, 10 AM, 4 PM, and 8 PM) across the day, to isolate the technical issues. The in-stock, technical issues, full OSS, and partial OSS may be determined using the Table 2 below:

TABLE 2

| | |
|---|---|
| In-stock | as per above explained approach |
| Technical | (Number of instance with ‘Inventory greater than zero and |
| Issue | in-stock equal to zero’)/Total No of instances |
| Full OOS | (Number of instance with ‘Inventory equal to zero and |
| | in-stock equal to zero’)/Total No of instances |
| Partial | (In-stock - Technical Issue - Full OOS) |
| in-stock | |

In another instance, to calculate the in-stock at Product*Dark store*Day for rolling, for example, four weeks and Product*Dark store*Day*Hour in-stock for rolling, for example, 7 days, the following inputs may be required:

Listings: All the active listings for a store in the data structure (Listing ID, Product ID, Dark store ID, Listing Status, Listing Created on).

Listing Availability: Chronological data for every listing id which gives the in-stock and OOS flag. Data Structure (Listing ID, Availability flag, timestamp).

Visits data: Day*Hour level visits data for every city.

For instance, using pre-determined promise engine data, a minute-by-minute availability of every product listing for in-stock metric may be computed, instead of the standard Product Page View (PPV) data or inventory data. Using the hourly traffic to the platform in a particular city as weight, a higher importance may be considered for product unavailability during peak sale period. Further, by comparing the existing approach of physically available inventory at the dark store with the product listing availability on the platform, an attribute of exact quantum of systemic/technical related issues to loss of sales may be determined.

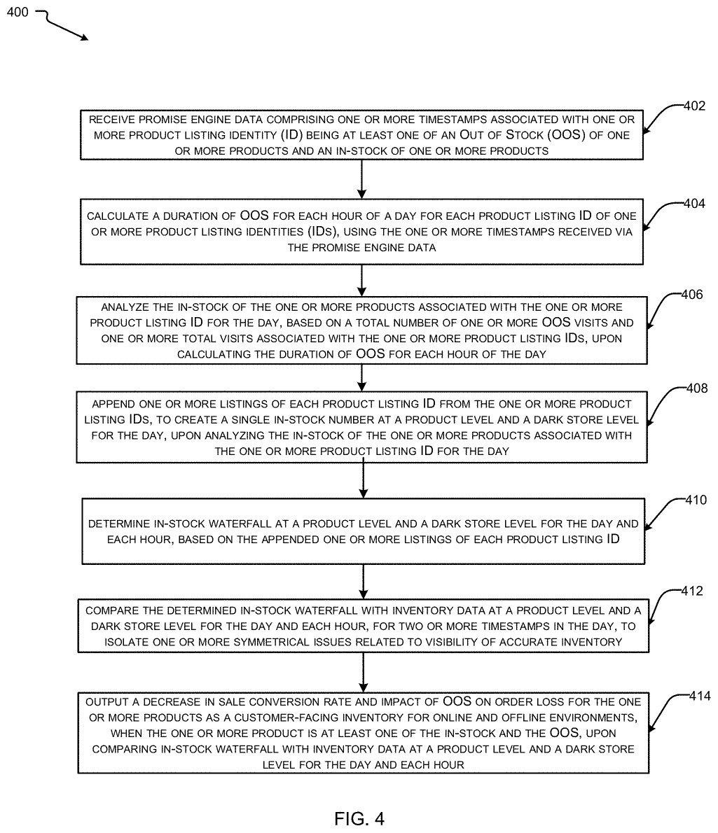

FIG. 4 illustrates a flow chart depicting a method 400 of determining customer-facing inventory for online and offline environments, according to embodiments of the present disclosure.

At block 402, the method 400 includes, receiving, by a processor 212 associated with an inventory system 210 (i.e., system 210), promise engine data comprising one or more timestamps associated with one or more product listing identity (ID) being at least one of an Out of Stock (OOS) of one or more products and an in-stock of one or more products.

At block 404, the method 400 includes calculating, by the processor 212, a duration of OOS for each hour of a day for each product listing ID of one or more product listing identities (IDs), using the one or more timestamps received via the promise engine data.

At block 406, the method 400 includes analyzing, by the processor 212, the in-stock of the one or more products associated with the one or more product listing ID for the day, based on a total number of one or more OOS visits and one or more total visits associated with the one or more product listing IDs, upon calculating the duration of OOS for each hour of the day. The OOS visits and the one or more total visits may be received via the promise engine data.

At block 408, the method 400 includes appending, by the processor 212, one or more listings of each product listing ID from the one or more product listing IDs, to create a single in-stock number at a product level and a dark store level for the day, upon analyzing the in-stock of the one or more products associated with the one or more product listing ID for the day.

At block 410, the method 400 includes determining, by the processor 212, in-stock waterfall at a product level and a dark store level for the day and each hour, based on the appended one or more listings of each product listing ID.

At block 412, the method 400 includes comparing, by the processor 212, the determined in-stock waterfall with inventory data at a product level and a dark store level for the day and each hour, for two or more timestamps in the day, to isolate one or more symmetrical issues related to visibility of accurate inventory.

At block 414, the method 400 includes outputting, by the processor 212, a decrease in sale conversion rate and impact of OOS on order loss for the one or more products as a customer-facing inventory for online and offline environments, when the one or more product is at least one of the in-stock and the OOS, upon comparing in-stock waterfall with inventory data at a product level and a dark store level for the day and each hour.

The order in which the method 400 are described is not intended to be construed as a limitation, and any number of the described method blocks may be combined or otherwise performed in any order to implement the method 400 or an alternate method. Additionally, individual blocks may be deleted from the method 400 without departing from the spirit and scope of the present disclosure described herein. Furthermore, the method 400 may be implemented in any suitable hardware, software, firmware, or a combination thereof, that exists in the related art or that is later developed. The method 400 describe, without limitation, the implementation of the system 210. A person of skill in the art will understand that method 400 may be modified appropriately for implementation in various manners without departing from the scope and spirit of the disclosure.

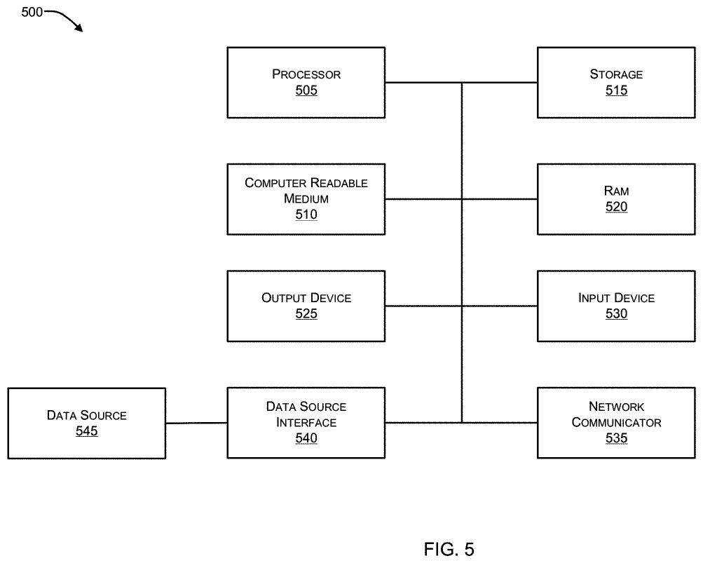

FIG. 5 illustrates a hardware platform 500 for implementation of the disclosed system 210, according to an example embodiment of the present disclosure. For the sake of brevity, construction and operational features of the system 210 which are explained in detail above are not explained in detail herein. Particularly, computing machines such as but not limited to internal/external server clusters, quantum computers, desktops, laptops, smartphones, tablets, and wearables which may be used to execute the system 210 or may include the structure of the hardware platform 500. As illustrated, the hardware platform 500 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 500 may be a computer system such as the system 210 that may be used with the embodiments described herein. The computer system may represent a computational platform that includes components that may be in a server or another computer system. The computer system may execute, by the processor 505 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and documents and analyze documents. In an example, the modules 304, may be software codes or components performing these steps.

The instructions on the computer-readable storage medium 510 are read and stored the instructions in storage 515 or in random access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interacting with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for instance. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as a limitation.

### Advantages of the Present Disclosure

The present disclosure provides a method and a system for determining customer-facing inventory for online and offline environments.

The present disclosure helps in leveraging promise engine data to provide a view of customer facing product availability at a granularity of every minute in every dark store.

The present disclosure provides an in-stock metric to help determine drop in conversion of product purchase.

The present disclosure helps in isolating systemic/technical issues related to the visibility of accurate inventory on a platform.

The present disclosure provides a weighted average of the product availability with traffic to the platform during that particular hour of the day, that enables in-stock metric more useful and helps with insights to ensure increased product availability during certain time of the day.

The present disclosure helps in comparing actual inventory snapshots with what is shown to the customer, which in turn helps with accurately identifying instances of product-dark store-hour combination, when technical related challenges led to drop in product availability. This information enables the teams to resolve technical related issues and ensure that all available inventory is visible in the platform.

The present disclosure compares existing approach of physically available inventory at the dark store with the product listing availability on the platform to attribute exact quantum of systemic/technical related issues to loss of sales.

What is claimed is:

1. A method for determining customer-facing inventory for online and offline environments, the method comprising:
receiving, by a processor associated with an inventory system, promise engine data comprising one or more timestamps associated with one or more product listing identity (ID) being at least one of an Out of Stock (OOS) of one or more products and an in-stock of one or more products;
calculating, by the processor, a duration of OOS for each hour of a day for each product listing ID of one or more product listing identities (IDs), using the one or more timestamps received via the promise engine data;
analyzing, by the processor, the in-stock of the one or more products associated with the one or more product listing ID for the day, based on a total number of one or more OOS visits and one or more total visits associated with the one or more product listing IDs, upon calculating the duration of OOS for each hour of the day, wherein the OOS visits and the one or more total visits is received via the promise engine data;
appending, by the processor, one or more listings of each product listing ID from the one or more product listing IDs, to create a single in-stock number at a product level and a dark store level for the day, upon analyzing the in-stock of the one or more products associated with the one or more product listing ID for the day;
determining, by the processor, in-stock waterfall at a product level and a dark store level for the day and each hour, based on the appended one or more listings of each product listing ID;
comparing, by the processor, the determined in-stock waterfall with inventory data at a product level and a dark store level for the day and each hour, for two or more timestamps in the day, to isolate one or more symmetrical issues related to visibility of accurate inventory; and
outputting, by the processor, a decrease in sale conversion rate and impact of OOS on order loss for the one or more products as a customer-facing inventory for online and offline environments, when the one or more product is at least one of the in-stock and the OOS, upon comparing in-stock waterfall with inventory data (320) at a product level and a dark store level for the day and each hour.

2. The method as claimed in claim 1, wherein creating the single in-stock number at the product level and the dark store level for the day further comprises:
sorting, by the processor, with respect to time, the appended one or more listings of each product listing ID in ascending order of the time;
incrementing, by the processor, a flag value, if the one or more products is OOS and decrementing the flag value, if the one or more products is in-stock;
determining, by the processor, if the flag value is equal to a number of appended one or more listings of each product listing ID; and
displaying, by the processor, all the appended listings as OOS, when the flag value is equal to the number of appended one or more listings of each product listing ID.

3. The method as claimed in claim 2, wherein the all the appended listings are displayed based on determining number of instances with inventory of one or more products equal to zero and in-stock of one or more products is equal to zero for a total number of instances.

4. The method as claimed in claim 1, wherein the promise engine data comprises a view of customer facing product availability at a granularity of every minute in each dark store.

5. The method as claimed in claim 1, wherein the in-stock comprises a partial in-stock, which is determined based on in-stock, symmetrical issue and OOS of all the appended listings, wherein the in-stock comprises a product listing availability which is determined based on chronological data for each product listing ID to provide a flag value for the in-stock and the OOS, and wherein the product listing availability comprises the one or more product listing IDs, availability flag, one or more timestamps.

6. The method as claimed in claim 1, wherein the one or more listings comprises at least one of listing IDs, product IDs, dark-store IDs, listing status, and listing creation information.

7. The method as claimed in claim 1, wherein the symmetrical issues comprise one or more technical issues, which is determined based on number of instances with inventory of one or more products greater than zero and in-stock of one or more products is equal to zero for a total number of instances.

8. The method as claimed in claim 1, wherein the one or more total visits comprises day level visits and hour level visits for every city.

9. An inventory system for determining customer-facing inventory for online and offline environments, the system comprising:
a processor;
a memory coupled to the processor, wherein the memory comprises processor executable instructions, which on execution, causes the processor to:
receive promise engine data comprising one or more timestamps associated with one or more product listing identity (ID) being at least one of an Out of Stock (OOS) of one or more products and an in-stock of one or more products;
calculate a duration of OOS for each hour of a day for each product listing ID of one or more product listing identities (IDs), using the one or more timestamps received via the promise engine data;
analyze the in-stock of the one or more products associated with the one or more product listing ID for the day, based on a total number of one or more OOS visits and one or more total visits associated with the one or more product listing IDs, upon calculating the duration of OOS for each hour of the day, wherein the OOS visits and the one or more total visits is received via the promise engine data;
append one or more listings of each product listing ID from the one or more product listing IDs, to create a single in-stock number at a product level and a dark store level for the day, upon analyzing the in-stock of the one or more products associated with the one or more product listing ID for the day;
determine in-stock waterfall at a product level and a dark store level for the day and each hour, based on the appended one or more listings of each product listing ID;
compare the determined in-stock waterfall with inventory data at a product level and a dark store level for the day and each hour, for two or more timestamps in the day, to isolate one or more symmetrical issues related to visibility of accurate inventory; and
output a decrease in sale conversion rate and impact of OOS on order loss for the one or more products as a customer-facing inventory for online and offline environments, when the one or more product is at least one of the in-stock and the OOS, upon comparing in-stock waterfall with inventory data at a product level and a dark store level for the day and each hour.

10. The inventory system as claimed in claim 9, wherein, for creating the single in-stock number at the product level and the dark store level for the day, the processor is further configured to:
sorting, by the processor, with respect to time, the appended one or more listings of each product listing ID in ascending order of the time;
incrementing, by the processor, a flag value, if the one or more products is OOS and decrementing the flag value, if the one or more products is in-stock;
determining, by the processor, if the flag value is equal to a number of appended one or more listings of each product listing ID; and
displaying, by the processor, all the appended listings as OOS, when the flag value is equal to the number of appended one or more listings of each product listing ID.

11. The inventory system as claimed in claim 10, wherein the all the appended listings is displayed based on determining number of instances with inventory of one or more products equal to zero and in-stock of one or more products is equal to zero for a total number of instances.

12. The inventory system as claimed in claim 9, wherein the promise engine data comprises a view of customer facing product availability at a granularity of every minute in each dark store.

13. The inventory system as claimed in claim 9, wherein the in-stock comprises a partial in-stock, which is determined based on in-stock, symmetrical issue and OOS of all the appended listings, wherein the in-stock comprises a product listing availability which is determined based on chronological data for each product listing ID to provide a flag value for the in-stock and the OOS, and wherein the product listing availability comprises the one or more product listing IDs, availability flag, one or more timestamps.

14. The inventory system as claimed in claim 9, wherein the one or more listings comprises at least one of listing IDs, product IDs, dark-store IDs, listing status, and listing creation information.

15. The inventory system as claimed in claim 9, wherein the symmetrical issues comprise one or more technical issues, which is determined based on number of instances with inventory of one or more products greater than zero and in-stock of one or more products is equal to zero for a total number of instances.

16. The inventory system as claimed in claim 9, wherein the one or more total visits comprises day level visits and hour level visits for every city.
